(19) United States
(12) Patent Application Publication
(10) Pub. No.: US 2014/0279882 A1
(43) Pub. Date: Sep. 18, 2014

(54) SYNCHRONIZATION OF CENTRALIZED SYSTEMS AND MEDICAL DEVICES

(71) Applicant: CAREFUSION 303, INC., San Diego, CA (US)

(72) Inventors: Aron Weiler, San Diego, CA (US); Martin Orona, San Diego, CA (US)

(73) Assignee: CareFusion 303, Inc., San Diego, CA (US)

(21) Appl. No.: 13/831,660

(22) Filed: Mar. 15, 2013

(51) Int. Cl. G06F 17/30

(52) U.S. Cl. CPC G06F 17/30575
USPC 707/617

(57) ABSTRACT

Application data and configuration data is stored for a medical device in a first centralized system and also stored in a second centralized system. The first and second centralized systems communicate via a network connection that is intermittently available. During a cessation of the network connection between the first and second centralized systems, a data update may occur by at least one of: pushing data from the first centralized system to at least one data store in the medical device, and pulling data from at least one data store in the medical device to the first centralized system. During a resumption of the network connection between the first and second centralized systems, at least one data store in the first centralized system may be synchronized with a corresponding at least one data store in the second centralized system. Related apparatus, systems, techniques, articles, and computer readable media are also described.

### TECHNICAL FIELD

The subject matter described herein relates to synchronization of data components between medical devices and a centralized system, and between centralized systems.

### BACKGROUND

To improve cost efficiency and patient care, hospitals and other care facilities are increasingly using medical devices such as vital signs monitors and infusion pumps. Increasingly, these devices are electronically controlled. These devices are typically programmable and contain application data, configuration data, and maintenance data. However, coordinating these medical devices to share information with a centralized system in a hospital environment can be difficult to efficiently implement. Outside the hospital environment, such as at a remote care facility, coordination with a centralized system at the hospital can be even more difficult due to the lack of network connectivity to the centralized system.

### SUMMARY

In one aspect, application data and configuration data is stored for a medical device in a first centralized system. The application data and the configuration data is also stored in a second centralized system. The first centralized system and second centralized system communicate via a network connection that is intermittently available. During a cessation of the network connection between the first centralized system and the second centralized system, a data update may occur by at least one of: pushing data from the first centralized system to at least one data store in the medical device, and pulling data from at least one data store in the medical device to the first centralized system. During a resumption of the network connection between the first centralized system and the second centralized system, at least one data store in the first centralized system may be synchronized with a corresponding at least one data store in the second centralized system.

The medical device may include one of an infusion pump, a syringe pump, a vital signs monitor, and a ventilator. Configuration data may include, for example, a syringe container type or size for use with the syringe pump. Application data may include, for example, a software component being executed on one or more medical devices. A data store may include at least one of a data store of device communications, a data store associated with a file transfer, and a data store associated with an editor.

In some implementations, the updating comprises at least one of: pushing data to the medical device including language data associated with a user interface, pushing data to the medical device including an update to firmware stored on the medical device, pushing data to the medical device including an update to an operating system stored on the medical device, pushing data to the medical device including a new application and/or an update to an application stored on the medical device, pushing data to the medical device including an update to configuration data stored on the medical device, pushing data to the medical device including an update to network configuration data for the medical device, pushing data to the medical device including synchronization of device communication related to a plurality of medical devices connected to the first centralized system, and/or pushing data to the medical device including an update to authorization data related to one or more users.

Computer program products are also described that comprise non-transitory computer readable media storing instructions, which when executed by one or more data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wide area network, a local area network, a wireless network, a wired network, or the like), via a direct connection between one or more of the multiple computing systems, etc.

The current subject matter provides many advantages. For example, the current subject matter enables enhanced synchronization amongst medical devices, centralized systems, components, and data stores which in turn allows for easier coordination and integration within a healthcare computing environment.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a computing landscape within a healthcare environment;

FIGS. 2A-2C are system diagrams illustrating data synchronization with a remote medical device.

FIG. 3 is a process diagram illustrating synchronization of data between a remote medical device and a centralized system, and between two centralized systems.

Like reference symbols in the various drawings indicate like elements.

### DETAILED DESCRIPTION

FIG. 1 is a system diagram illustrating a computing landscape 100 within a healthcare environment such as a hospital. Various devices and systems, both local to the healthcare environment and remote from the healthcare environment, can interact via at least one computing network 105. This computing network 105 can provide any form or medium of digital communication connectivity (e.g., wired connection, optical connection, wireless connection, and so forth) amongst the various devices and systems. Examples of communication networks include a local area network (“LAN”), a wide area network (“WAN”), and the Internet. In some cases, one or more of the various devices and systems can interact directly via peer-to-peer coupling (for example, via a hardwired connection or via a wireless protocol such as Bluetooth or WiFi). In addition, in some variations, one or more of the devices and systems communicate via a cellular data network.

In particular, aspects of the computing landscape 100 can be implemented in a computing system that includes a back-end component (e.g., as a data server 110), or that includes a middleware component (e.g., an application server 115), or that includes a front-end component (e.g., a client computer 120 having a graphical user interface or a Web browser through which a user may interact with an implementation of the subject matter described herein), or any combination of such back-end, middleware, or front-end components. A client 120 and server 110, 115 are generally remote from each other and typically interact through the communications network 105. The relationship of the clients 120 and servers 110, 115 arises by virtue of computer programs running on the respective computers and may have a client-server relationship to each other. Clients 120 can be any of a variety of computing platforms that include local applications for providing various functionality within the healthcare environment. Example clients 120 include, but are not limited to, desktop computers, laptop computers, tablets, and other computing devices that may have touch-screen interfaces. The local applications can be self-contained in that they do not require network connectivity and/or they can interact with one or more of the servers 110, 115 (e.g., a web browser).

A variety of applications can be executed on the various devices and systems within the computing landscape such as electronic health record applications, medical device monitoring, operation, and maintenance applications, scheduling applications, billing applications, and the like.

The network 105 can be coupled to one or more data storage systems 125. The data storage systems 125 can include databases providing physical data storage within the healthcare environment or within a dedicated facility. In addition, or in the alternative, the data storage systems 125 can include cloud-based systems providing remote storage of data in, for example, a multi-tenant computing environment. The data storage systems 125 can also comprise non-transitory computer readable media.

Mobile communications devices (MCDs) 130 can also form part of the computing landscape 100. The MCDs 130 can communicate directly via the network 105 and/or they can communicate with the network 105 via an intermediate network such as a cellular data network or other wired or wireless network. Various types of communication protocols can be used by the MCDs 130 including, for example, messaging protocols such as SMS and MMS.

Various types of medical devices 140 can be used as part of the computing landscape 100. These medical devices 140 can comprise, unless otherwise specified, any type of device or system with a communications interface that characterizes one or more physiological measurements of a patient and/or that characterizes treatment of a patient. In some cases, the medical devices 140 communicate via peer to peer wired or wireless communications with another medical device 140 (as opposed to communicating with the network 105). For example, the medical device 140 can comprise a bedside vital signs monitor that is connected to other medical devices 140, namely a wireless pulse oximeter and to a wired blood pressure monitor. One or more operational parameters of the medical devices 140 can be locally controlled by a clinician, controlled via a clinician via the network 105, and/or they can be controlled by one or more of a server 115, client 120, data storage systems 125, MCD 130, and/or another medical device 140.

The computing landscape 100 can provide various types of functionality as may be required within a healthcare environment such as a hospital. For example, a pharmacy can initiate a prescription via one of the client computers 120. This prescription can be stored in the data storage systems 125 and/or pushed out to other clients 120, an MCD 130, and/or one or more of the medical devices 140. In addition, the medical devices 140 can provide data characterizing one or more physiological measurements of a patient and/or treatment of a patient (e.g., medical device 140 can be an infusion management system, etc.). The data generated by the medical devices 140 can be communicated to other medical devices 140, the servers 110, 115, the clients 120, the MCDs 130, and/or stored in the data storage systems 125.

In some implementations consistent with FIG. 1, the computing landscape 100 includes a centralized system, medical devices 140, network 105, and cellular network 135. The centralized system includes one or more of clients 120, backend server(s) 110, application server(s) 115, data storage systems 125, and MCD 130. Computing devices 110, 115, 120, 125, and 130 may connect to the network 105 through any wired or wireless access network including cellular data network 135 or other network. Some medical devices can connect directly to network 105.

FIG. 2A depicts an example of a logical instance 200 of a centralized system (CS). The logical instance 200 of the CS can include a complete CS for a hospital, building, company, organization, or location. In some implementations such as the logical instance in FIG. 2A, the logical instance can include multiple physical instances 210, 220 of centralized systems connected through a network such as network 105. Application data and configuration data stored on centralized system 210 can also be stored on centralized system 220. A physical instance such as centralized system 220 may reside on a laptop or other portable computing device while another physical instance such as centralized system 210 may reside on a central computer system in a hospital, for example. A physical instance such as centralized system 210 may reside on a plurality of computing systems that make up a central computing facility at a hospital, for example.

In the example shown in FIG. 2A, the logical instance 200 includes two physical instances—centralized system 210 and centralized system 220. The centralized systems are connected together through network 105. Centralized system 210 can be also connected to one or more medical devices 140. In some systems, the centralized system such as centralized system 210 can be connected to a large number of medical devices (e.g., thousands of medical devices, etc.). Although not shown in FIGS. 2A-2C, one or more centralized systems such as centralized systems 210 and 220 can be connected to the internet.

Network 105 provides for communication through connections 205 between computing devices such as centralized systems 210, 220, and communication through connections 205 between medical devices 140 and centralized systems 210, 220. Centralized systems 210, 220 can also have a connection to the internet. A user at a user interface, can access the CS through a network connection 205. Each connection 205 can be a wired or wireless connection, a serial connection, parallel connection or any other type of communication connection. Connections 205 can also include additional gateways or routers to provide access through the internet.

A centralized system such as centralized system 210 can connect to between one and thousands of medical devices. In the example of FIG. 2A, centralized system 210 connects to medical devices 140 and centralized system 220 through network 105. When multiple medical devices are connected to a centralized system they can connect through a switch or router not shown in FIGS. 2A-2C. The connections 205 between medical devices 140 and the centralized system can be wired or wireless connections, or any combination of wired and wireless connections. The CS such as centralized system 210 can provide commands that are individually addressed to one of the connected medical devices, or commands can be broadcast to multiple medical devices. Status data, maintenance data, usage data, and other data can be received at the centralized system from any attached medical device. Each centralized system such as centralized system 210 can maintain a list of medical devices connected to it such as medical devices 140. The list of medical devices connected to the CS 200 is sometimes referred to as a registry.

A user interface (e.g., a graphical user interface, etc.) to access a centralized system can facilitate sending commands and receiving information from any device in the CS 200. Before sending commands or accessing information, authentication of the user at the user interface may be required by the CS 200. For example, a user at a user interface can access the CS through a connection to network 105 or through the internet. The user at the user interface can be required to provide authentication information at the user interface, at the centralized system 210, 220 or both. Upon authentication, the user can send commands to medical devices 140 connected to the CS and/or receive information form the medical devices 140 or centralized systems 210, 220. The authentication credentials of a user can limit the types of commands that a user is allowed to send, the types of information the user is allowed to receive, and/or or the medical devices that the user may access. For example, a particular user may be able to receive only maintenance information from the medical devices on the CS 200 and no other information, and may not be allowed to send commands to the medical devices. For example, these limitations or similar limitations can be imposed on maintenance personnel at a hospital. Other examples include the physician for a patient who may be authorized to adjust a dosage level at a medical device where maintenance personnel would not be authorized to adjust dosages. Other limitations or sets of limitations are also possible.

In FIG. 2A, medical devices 140 are connected to centralized system 210 through network 105, but medical device 230 is not connected to a centralized system or to network 105. There are a number of possible causes that may result in medical device 230 not being connected to a centralized system or the network. For example, medical device 230 may be physically located away from the hospital or central facility such as in a patient's home or in a remote clinic. Because medical device 230 is not connected to a centralized system, data cannot be exchanged between a centralized system and medical device 230. Despite the lack of connectivity between medical device 230 and a centralized system, medical device 230 can still perform its intended function as a medical device.

Medical devices such as medical devices 140, 230 can include any combination of devices such as infusion pumps (e.g., peristaltic pumps, large volume infusion pumps, syringe pumps, patient-controlled analgesia systems, etc.), ventilators, vital signs monitors, and other network enabled medical devices

Some information stored on a centralized system such as centralized system 210 can be shared with other centralized systems such as centralized system 220. This process is sometimes called synchronization. Synchronization can involve synchronization components such as synchronization of device communications, synchronization of data stores including application data and configuration data, synchronization of file transfers, synchronization of routing, and synchronization of editor information. Other types of synchronization are also possible.

Application data can include executable programs and updates to executable programs. Configuration data can include parameter values needed by the centralized system or any of the medical devices in order to operate.

Synchronization of device communications can involve the servers such as servers 210, 220 exchanging information about the medical devices connected to each server. The information exchanged about any particular medical device can be called a device data package and can include identification of the type of device, the status of the device, the location of the device and other parameters.

A centralized system such as centralized system 220 may reside on a portable computing device or a desktop computing device. Portable computing devices include laptop computers, notebook computers, netbook computers, tablet computers, personal digital assistants (PDAs), smartphones, and others such as custom designed computing devices. Centralized system 220 can be synchronized with centralized system 210 automatically or via a command. For example, centralized systems 210, 220 may be configured to automatically synchronize data between centralized systems 210 and 220 anytime centralized system 210 and centralized system 220 are able to communicate through a network connection 205 and network 105, or other communications interface. For example, automatic synchronization can be part of the configuration data of centralized systems 210, 220 that causes the synchronization of data anytime centralized system 220 changes from being disconnected from centralized system 210 to being connected to centralized system 210, or anytime the data changes on either of centralized systems 210, 220 while they are connected.

Centralized systems 210, 220 can be configured to synchronize data between them based on a command. For example, a user at a user interface can initiate synchronization of centralized systems 210, 220 via the command. The user may be located in a hospital, building, or facility, or the user may be at another location. The user can access a centralized system such as 210, 220 via a user interface through network 105 or the internet. Alternatively, the user can be co-located with centralized system 210,220. Data synchronized between centralized systems 210, 220 can include data pertaining to medical devices 140 including medical device 230, data pertaining to users of the centralized system, data pertaining to facilities, configuration data, and commands to remote medical devices such as medical device 230. For example, data that is synchronized can include any medical device data needed by the medical device to operate. For an infusion pump, this may include data that characterizes syringe containers, syringe sizes, hoses, and other device specific information. Firmware may be synchronized by loading updates or complete firmware packages from the centralized system to the medical device. Operating system updates can be provided via synchronization. Applications running on the medical device can be added or updated during synchronization. Configuration data including network configuration information applicable to the medical device can be added or updated during synchronization. Network configuration information can include wired or wireless network set-up information such as an internet protocol address and other set-up parameter values. Information about authorized users may be synchronized. For example, a list of authorized users by name or identifier may be updated or added and/or the authorization information related to categories of users such as maintenance workers, nurses, physicians, and so forth. Data that is synchronized can also include patient treatment data such as a treatment order or change order. Data that is synchronized between centralized systems 210 and 220 can include data that is targeted for or requested from a medical device such as medical device 230. Data that is synchronized can also include language data associated with a user interface to the centralized system or to a medical device. For example, the user interface of a medical device may be updated to support German.

In FIG. 2B, the network connection 205 between network 105 and centralized system 220 becomes unavailable. The network connection between centralized system 220 and network 105 may become unavailable due to an action or may become unavailable passively. For example, an action such as the physical disconnection of a network cable or disabling of a wireless network device can cause the network connection to become unavailable. Alternatively, the network connection may become unavailable passively by centralized system being out of range of a wireless network connection. In the example of FIG. 2B, medical device 230 is located at a remote location such as a patient's residence, rural hospital, or clinic where the remote location does not have connectivity to network 105. Centralized system 220 has been synchronized with centralized system 210. The data synchronized between centralized systems 210 and 220 includes data that can later be pushed to medical device 230. The data synchronized may also include commands to be issued to medical device 230 and/or requests for data to be pulled from medical device 230.

Commands and messages can be sent to a remote medical device such as medical device 230. For example, a user at a user interface connected to centralized system 210 in FIG. 2A may issue a command that is stored at centralized systems 210, 220 or sent from centralized system 210 to centralized system 220 as part of the synchronization of centralized systems 210, 220. The command to medical device 230 can be stored on centralized system 220. When medical device 230 is connected to centralized system 220 in FIG. 2B, the command can be sent via connection 207 from centralized system 220 to medical device 230.

In FIG. 2C, centralized system 220 interfaces with medical device 230 via connection 207. Centralized system 220 synchronizes data with medical device 230 by pushing data from centralized system 230 to medical device 230 and/or pulling data from medical device 230 to centralized system 220. Data synchronized between centralized system 220 and medical device 230 includes data required to operate medical device 230, data pertaining to users of the centralized system, data pertaining to facilities, and configuration data. For example, data that is synchronized can include any medical device data needed by the medical device 230 to operate. For an infusion pump, this may include data that characterizes syringe containers, syringe sizes, hoses, and other device specific information. Firmware may be synchronized by loading firmware updates, or complete firmware packages may be loaded from centralized system 220 to medical device 230. Operating system updates can be provided via synchronization. Applications running on medical device 230 can be added or the installed applications can be updated during synchronization. Configuration data including network configuration information applicable to medical device 230 can be added or updated during synchronization. Network configuration information can include wired or wireless network set-up information such as an internet protocol address and other set-up parameter values. Information about authorized users may be synchronized. For example, a list of authorized users by name or identifier may be updated or added and/or the authorization information related to categories of users such as maintenance workers, nurses, physicians, and others can be added or updated. Data that is synchronized can also include patient treatment data such as a treatment order or change order. Data that is synchronized can also include language data associated with a user interface to medical device 230. For example, the user interface of a medical device may be updated to support German.

FIG. 3 depicts a process for synchronizing data between a first centralized system (e.g. 210) and a second centralized system (e.g. 220), followed by synchronization of the second centralized system with a medical device (e.g. 230), followed by synchronization of the second centralized system with the first centralized system including any new data received from the medical device. Medical device 230 may be one of a plurality of medical devices that can be connected to centralized system 220. At 310, application data and configuration data to be synchronized with medical device 230 is stored on centralized systems 210, 220. Centralized systems 210 and 220 are able to communicate with one another via connections 205 through network 105. The network connection can be intermittent—being available sometimes and unavailable at other times. For example, the connection can be available at locations where centralized systems 210 and 220 are connected via a wired or wireless service and unavailable in locations where there is no service such as at a remote location. At 330, the network connection between centralized systems 210 and 220 may be unavailable. Because the connection is unavailable, centralized systems 210 and 220 are not in communication with one another. For example, centralized system 220 may have been taken to a remote location where no network service is available to connect centralized systems 210 and 220. Upon establishing a connection such as connection 207 between centralized system 220 and medical device 230, medical device 230 can be synchronized with centralized system 220. Synchronization can include pushing data from centralized system 220 to medical device 230 and/or pulling data to centralized system from medical device 230. At 350, the network connection between the two centralized systems 210, 220 may be re-enabled, reconnected, or re-established. After the connection is re-established, the data stored on centralized systems 210 and 220 can be synchronized.

At 310, application data and configuration data are stored for a medical device such as medical device 230 in two centralized systems; a first centralized system such as centralized system 210 and a second centralized system such as centralized system 220. The data in the two centralized systems 210, 220 relative to the particular medical device can be the same. The first centralized system can communicate with the second centralized system via an interface such as connections 205 through network 105. For example, a portable centralized system (e.g. 220) such as a laptop computer may be synchronized with a centralized system of a hospital or central facility (e.g. 210). The network connection between the centralized system 210 and the centralized system 220 is intermittent. For example, disconnecting a centralized system 220 from the centralized system 210 may include unplugging a network cable, USB cable, other cable, or disabling a wireless network in the portable computer by shutting down the computer or disabling a wireless feature. A portable centralized system such as centralized system 220 in FIG. 2B can be a stand-alone centralized system. A stand-alone centralized system can perform all of the functions of centralized system 210 or a subset of the functions of centralized system 210, the subset determined by the configuration data associated with centralized system 220.

At 330, a medical device such as medical device 230 can be synchronized to the second centralized system such as centralized system 220 in FIG. 2C. Synchronizing includes updating, by at least one of pushing data from centralized system 220 to at least one data store in medical device 230, and pulling data from at least one data store in medical device 230 to centralized system 220. Data synchronized between centralized system 220 and medical device 230 includes data required to operate medical device 230, data pertaining to users of the centralized system, data pertaining to facilities, and configuration data. For example, data that is synchronized can include any medical device data needed by the medical device 230 to operate. For an infusion pump, this may include data that characterizes syringe containers, syringe sizes, hoses, and other device specific information. Firmware may be synchronized by loading firmware updates, or complete firmware packages may be loaded from centralized system 220 to medical device 230. Operating system updates can be provided via synchronization. Applications running on medical device 230 can be added or the installed applications can be updated during synchronization. Configuration data including network configuration information applicable to medical device 230 can be added or updated during synchronization. Network configuration information can include wired or wireless network set-up information such as an internet protocol address and other set-up parameter values. Information about authorized users may be synchronized. For example, a list of authorized users by name or identifier may be updated or added and/or the authorization information related to categories of users such as maintenance workers, nurses, physicians, and others can be added or updated. Data that is synchronized can also include patient treatment data such as a treatment order or change order. Data that is synchronized can also include language data associated with a user interface to medical device 230. For example, the user interface of a medical device may be updated to support German.

At 350, the second centralized system such as centralized system 220 may be reconnected to the first centralized system such as centralized system 210. The reconnection can include connecting a network cable from centralized system 220 to the network such as network 105, or may include enabling a wireless connection between the centralized system 220 and the network 105 connected to centralized system 210. Reconnection can also include a serial or parallel connection over which data can be exchanged between centralized systems 210 and 220.

Also at 350, centralized system 210 is synchronized with centralized system 220 using connection 205 between centralized system 210 and centralized system 220. The synchronizing includes synchronizing at least one data store in centralized system 210 with a corresponding at least one data store in centralized system 220. Synchronization includes exchanging any new or updated application data, configuration data, or maintenance data between centralized systems 210, 220.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter.

Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method comprising:
storing application data and configuration data for a medical device in a first centralized system and storing the application data and the configuration data in a second centralized system, the first centralized system communicating with the second centralized system via a network connection, the network connection being intermittently available;
updating, during a cessation of the network connection between the first centralized system and the second centralized system, by at least one of:
(i) pushing data from the first centralized system to at least one data store in the medical device, and
(ii) pulling data from at least one data store in the medical device to the first centralized system;
synchronizing, during a resumption of the network connection between the first centralized system and the second centralized system, at least one data store in the first centralized system with a corresponding at least one data store in the second centralized system.

2. The computer-implemented method of claim 1, wherein the medical device comprises a syringe pump and the configuration data characterizes at least one syringe container for use with the syringe pump.

3. The computer-implemented method of claim 1, wherein the updating comprises pushing data to the medical device including language data associated with a user interface.

4. The computer-implemented method of claim 1, wherein the updating comprises pushing data to the medical device including an update to firmware stored on the medical device.

5. The computer-implemented method of claim 1, wherein the updating comprises pushing data to the medical device including an update to an operating system stored on the medical device.

6. The computer-implemented method of claim 1, wherein the updating comprises pushing data to the medical device including at least one of a new application and an update to an application stored on the medical device.

7. The computer-implemented method of claim 1, wherein the updating comprises pushing data to the medical device including an update to configuration data stored on the medical device.

8. The computer-implemented method of claim 1, wherein the updating comprises pushing data to the medical device including an update to network configuration data for the medical device.

9. The computer-implemented method of claim 1, wherein the updating comprises pushing data to the medical device including synchronization of device communication related to a plurality of medical devices connected to the first centralized system.

10. The computer-implemented method of claim 1, wherein the updating comprises pushing data to the medical device including an update to authorization data related to one or more users.

11. The computer-implemented method of claim 1, wherein the medical device comprises one of an infusion pump, a vital signs monitor, and a ventilator.

12. The computer-implemented method of claim 1, wherein the application data comprises a software component being executed on one or more medical devices.

13. The computer-implemented method of claim 1, wherein the at least one data store comprises at least one of a data store of device communications, a data store associated with a file transfer, and a data store associated with an editor.

14. A non-transitory computer readable medium encoded with instructions which, when executed by at least one processor, perform at least the following:
store application data and configuration data for a medical device in a first centralized system and storing the application data and the configuration data in a second centralized system, the first centralized system communicating with the second centralized system via a network connection, the network connection being intermittently available;
update, during a cessation of the network connection between the first centralized system and the second centralized system, by at least one of:
(i) pushing data from the first centralized system to at least one data store in the medical device, and
(ii) pulling data from at least one data store in the medical device to the first centralized system;
synchronize, during a resumption of the network connection between the first centralized system and the second centralized system, at least one data store in the first centralized system with a corresponding at least one data store in the second centralized system.

15. The non-transitory computer readable medium of claim 14, wherein the update comprises pushing data to the medical device including updated configuration data stored on the medical device.

16. The non-transitory computer readable medium of claim 14, wherein the update comprises pushing data to the medical device including synchronization of device communication related to a plurality of medical devices connected to the first centralized system.

17. The non-transitory computer readable medium of claim 14, wherein the medical device comprises one of an infusion pump, a vital signs monitor, and a ventilator.

18. An apparatus comprising:
at least one processor; and
at least one memory storing computer program code, the at least one processor, the at least one memory, and the computer program code configured to cause the apparatus to at least:
store application data and configuration data for a medical device in a first centralized system and storing the application data and the configuration data in a second centralized system, the first centralized system communicating with the second centralized system via a network connection, the network connection being intermittently available;
update, during a cessation of the network connection between the first centralized system and the second centralized system, by at least one of:
(i) pushing data from the first centralized system to at least one data store in the medical device, and
(ii) pulling data from at least one data store in the medical device to the first centralized system;
synchronize, during a resumption of the network connection between the first centralized system and the second centralized system, at least one data store in the first centralized system with a corresponding at least one data store in the second centralized system.

19. The apparatus of claim 18, wherein the update comprises pushing data to the medical device including an update to configuration data stored on the medical device.

20. The apparatus of claim 18, wherein the update comprises pushing data to the medical device including synchronization of device communication related to a plurality of medical devices connected to the first centralized system.
